(19) United States
(12) Patent Application Publication
(10) Pub. No.: US 2005/0055516 A1
(43) Pub. Date: Mar. 10, 2005

(54) Method and apparatus for hardware data speculation to support memory optimizations

(76) Inventors: Vijay S. Menon, Seattle, WA (US); Brian Murphy, Mountain View, CA (US); Ali-Reza Adl-Tabatabai, Santa Clara, CA (US); Tatiana Shpeisman, Menlo Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/658,897

(22) Filed: Sep. 10, 2003

(51) Int. Cl. G06F 12/00

(52) U.S. Cl. 711/158; 711/167

(57) ABSTRACT

According to one embodiment a computer method and apparatus for causing a computer to perform a speculative read re-ordered load is disclosed. A speculative read re-ordered load instruction is inserted into the instruction sequence to optimize the code. Memory conflict information representing the speculative read re-ordered load is stored. When a later potentially conflicting load is executed, its physical address is matched against the physical address of the stored memory conflict information. If the potentially conflicting load has a matching physical address and a different value than the stored memory conflict information representing the speculative read re-ordered load, then the stored memory conflict information is invalidated.

### FIELD OF THE INVENTION

The present invention relates to computer systems; more particularly, the present invention relates to a computer system for efficiently implementing load speculation.

### BACKGROUND

A computer program includes numerous instructions, which direct a processor as to what it must do to achieve the desired goal of the program. The processor runs a particular program by executing instructions included in that program.

One bottleneck in supplying the processor with data/instructions is the relatively long latency of load operations that transfer data from the system's memory into the processor's registers. A typical memory system includes a hierarchy of caches and a main memory. The latency of the load depends on where in the hierarchy the targeted data is found, e.g. the cache in which the load operation “hits”. In the sequence of instructions contained in a computer program, a load instruction often closely precedes the instruction that acts upon the data loaded. Because such an instruction needs to wait for the load operation to complete before it can begin its execution, time spent waiting for completion of the load operation delays execution of the computer program.

To avoid idling the processor, a compiler typically schedules load operations in a program flow well before the operation that uses the target data. Moving the load up-stream from its normal position in the sequence of instructions is sometimes called advancing the load or reordering the load. Thus the load operation is started as early as possible, giving as much time as possible for the load operation to complete before any instructions dependent on the load are encountered in the sequence of instructions.

Some computer programming languages require coherency, and part of this requirement is that (1) for any given memory location, all loads and assignments to that location must be totally ordered over all threads, and (2) this total ordering must be consistent with the program order for each thread. A direct implication of this requirement is that any two load operations that may access the same memory location must not be reordered. This is called the read-kills constraint. Compiler scheduling occurs before the program is executed and, consequently, before any run-time information is available. As a result, the compiler cannot determine statically whether two load operations may or may not reference the same memory location, and therefore cannot reorder the loads.

The read kills constraint is implemented to ensure data integrity with the emergence of multi-threaded programs and multi-processor computers with many threads and programs potentially accessing the same memory locations and data simultaneously. Implementing the read kills constraint comes at the expense of efficiency, as it severely limits the ability of the compiler to perform important, performance-enhancing optimizations that eliminate or reorder loads to memory. The performance penalties of forgoing memory optimizations will be particularly severe for architectures that rely on optimizations such as store-forwarding, redundant load elimination, and control speculation for performance. Therefore, a form of data speculation is needed that will allow for optimal ordering of load instructions without violating the read kills constraint.

Existing forms of data speculation reorder potentially conflicting loads ahead of stores, but none have addressed data speculation under the read-kills constraint. Furthermore, existing forms of data speculation operate by comparing the memory addresses that the potentially conflicting load and store instructions access. If the instructions accessed the same memory address, then recovery code would be executed that runs the speculative load again. But, these forms of data speculation do not account for potentially conflicting instructions that access the same memory location, but also load the same value in that location. As a result, a speculative load that references the same memory address as a potentially conflicting load, but also loads the same value, is invalidated even though the speculative load could be dependably executed.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a computer system.

FIG. 2 illustrates a flowchart representing one embodiment for a method of implementing a read re-ordered load operation using a read re-ordered load address table (RRLAT) to track potentially conflicting load operations.

FIG. 3a illustrates an initial code instruction sequence.

FIG. 3b illustrates an incorrect optimization of the instruction sequence.

FIG. 3c illustrates the processes of one embodiment optimizing an instruction sequence.

FIG. 4 illustrates one embodiment of details of a RRLAT.

### DETAILED DESCRIPTION

A method and apparatus for efficiently performing load operations speculatively under a read kills constraint is disclosed. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs), execution cores, etc.).

In the following discussion, a read re-ordered load refers to a load operation that is scheduled ahead of other potentially conflicting loads. The read re-ordered load and the potentially conflicting load may reference memory addresses that overlap. When the memory addresses overlap, the loads are said to collide. Embodiments of the present invention employ a read re-ordered load check instruction to detect these collisions.

Also in the following discussion, the read kills constraint refers to the coherency requirement of a programming language that specifies for any memory location, each thread's reads and writes of that location must occur in a program-specified order, and operations by all threads on that location are serialized. In particular, reordering of loads to the same memory location in a program is forbidden under this constraint. This requirement is implemented to ensure data integrity across a computer system, with one processor or multiple processors, that is running different threads and programs simultaneously.

Implementing the read kills constraint comes at the expense of efficiency, as it severely limits the ability of the compiler to perform important, performance-enhancing optimizations that eliminate or reorder loads to memory. The performance penalties of forgoing memory optimizations will be particularly severe for architectures that rely on optimizations such as store-forwarding, redundant load elimination, and control speculation for performance. Therefore, embodiments of the present invention introduce a form of data speculation that allows for optimal ordering of load instructions without violating the read kills constraint.

In one embodiment, mechanisms to check for collisions between read re-ordered loads and potentially conflicting loads are employed. The mechanism reduces the performance penalties for observing the read kills constraint and increases the compiler's ability to determine when loads may be ordered efficiently. For example, one such mechanism compares a memory address as well as the value located at that memory address to predict whether a collision occurs.

In one embodiment, provided is a set of instructions which, when executed by a computer, allow the computer to perform load operations speculatively under a read kills constraint by performing certain processes. The processes may include replacing a load instruction located at a particular location in the computer program instruction sequence with two instructions, a speculative read re-ordered load instruction (“ld.rr”) and a read re-ordered load check instruction (“check.rr”).

The read re-ordered load is inserted into the instruction sequence up-stream of the particular location at which the original load instruction was previously located (this may include placement of the read re-ordered load up-stream of loads which preceded the original load in the program order and may be potentially conflicting under the read kills constraint). The read re-ordered load check instruction is typically inserted into the instruction sequence at the particular location where the original load instruction was previously located. Other embodiments of the invention may place the read re-ordered load instruction elsewhere in the instruction sequence.

Executing the read re-ordered load instruction causes the computer to perform the load operation that would have been performed by the original load instruction, earlier in the instruction sequence. Executing the read re-ordered load check instruction determines whether the read re-ordered load data may be used. If the read re-ordered load data may be used, the read re-ordered load check instruction is treated as a non-operational instruction. If the read re-ordered load data may not be or should not be used, the read re-ordered load check instruction causes the computer to perform a recovery operation.

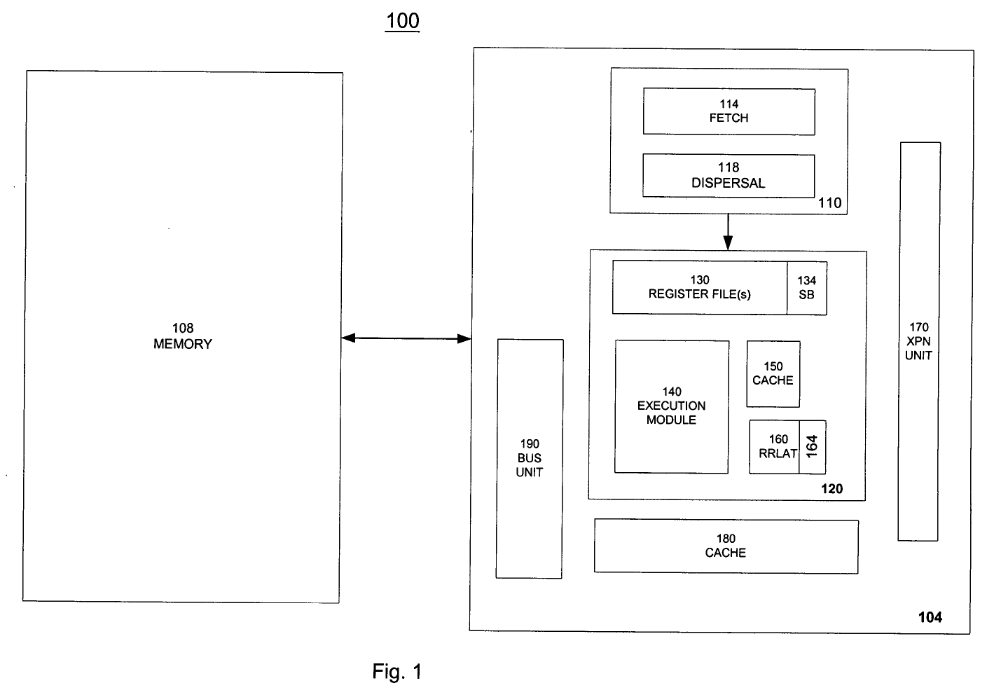

FIG. 1 is a block diagram of one embodiment of a computer system 100. System 100 includes a processor 104 and a memory 108 that are typically coupled through system logic (not shown). Although the computer system in FIG. 1 is disclosed as including only a single processor 104, one of ordinary skill in the art will appreciate that the computer system may include multiple processors.

The resources of processor 104 are organized into an instruction execution pipeline having a front end 110 and a back end 120. Front end 110 fetches instructions and issues them to resources in back end 120 for execution. The disclosed embodiment of front end 110 includes a fetch unit 114 and a decoder or dispersal unit 118. Fetch unit 114 includes circuitry to retrieve instructions from various memory structures, e.g. memory 108 or an instruction cache (not shown), and provide them to the other resources of processor 104. Fetch unit 114 also typically includes branch prediction resources to anticipate control flow changes and an instruction cache to store instructions for processing. The fetched instructions are provided to dispersal unit 118, which includes circuitry to direct them to appropriate resources in back end 120 for execution.

According to one embodiment, processor 104 fetches and issues multiple instructions on each cycle of the processor clock. Instructions issued to back end 120 concurrently are referred to as an issue group. The instructions of an issue group are staged down the instruction execution pipeline together.

For the disclosed embodiment of processor 104, back end 120 includes a register file 130, execution module 140, a primary cache 150, and a read re-ordered load address table (RRLAT) 160. A scoreboard 134 is associated with register file 130 to track the availability of data in the entries (“registers”) of register file 130. Execution module 140 typically includes different execution units for the different types of instructions. For example, execution module 140 may include one or more integer (IEU), memory (MU), floating point (FPU), and branch (BRU) execution units to handle integer, load/store, floating point, and branch operations, respectively.

The disclosed embodiment of processor 104 also includes an exception/commit unit (XPN) 170, a secondary cache 180, and a bus unit 190. Bus unit 190 controls communications between processor 104 and off-chip resources such as memory 108 and off-chip caches if present (see below). XPN 170 monitors the various resources in front end 110 and back end 120 to determine which instructions should be retired when they reach the end of the instruction execution pipeline. In particular, XPN 170 monitors these resources for exceptional conditions (“exceptions”) and adjusts the instruction flow through processor 104 accordingly. For one embodiment, XPN 170 monitors RRLAT 160 to determine whether a read re-ordered load check instruction fails and adjusts the operation of processor 104 when a failing read re-ordered load check instruction is detected.

Embodiments of processor 104 may include tertiary and higher level caches (not shown). For example, a tertiary cache may be included on the same chip as processor 104 or on a separate chip. When a tertiary cache is provided off-chip, bus unit 190 controls communications between processor 104 and the off-chip cache. Caches 150, 180 (plus any higher level caches) and memory 108 form a memory hierarchy for computer system 100 to provide data to the resources of back end 120. The present invention does not depend on the detailed structure of the memory hierarchy.

Instructions issued to back end 120 operate on data (operands) that are provided from register file 130 or bypassed to execution module 140 from various components of the memory hierarchy or other execution units. Register file 130 may include separate register files for integer and floating point data. Scoreboard 134 is used to track the availability of data in the entries (“registers”) of register file 130. Operand data is transferred to and from these registers through various types of load and store operations, respectively, and scoreboard 134 is updated accordingly. A load operation searches the memory subsystem for data at a specified memory address, and returns the data to register file 130 from the level of the hierarchy nearest to the processor core in which the requested data is available. A store writes data from a register in file 130 to one or more levels of the memory hierarchy.

RRLAT 160 includes multiple entries to track the memory addresses of data targeted by read re-ordered load operations. For one embodiment of RRLAT 160, each entry can be set to indicate the target memory address of a read re-ordered load, the register for which the contents of the target memory address are destined (“target register”), the value to be stored in the target register, and the validity status of the target address.

RRLAT 160 also includes a monitor unit 164 to observe selected load and store transactions and update the RRLAT 160 entries accordingly. For example, if an address targeted by potentially conflicting load overlaps a target address, and the value located in the potentially conflicting load is not equal to the value located at the target address in RRLAT 160, a validity bit is set to indicate that the entry is no longer valid. RRLAT 160 will be described in greater detail below.

For one embodiment, a corresponding bit in a scoreboard unit is updated to indicate that data returned by the read re-ordered load is not valid. The collision between the read re-ordered load and the potentially conflicting load addresses means the data returned by the read re-ordered load may be stale. A read re-ordered load check instruction triggers a read of RRLAT 160 to determine if a recovery operation is necessary.

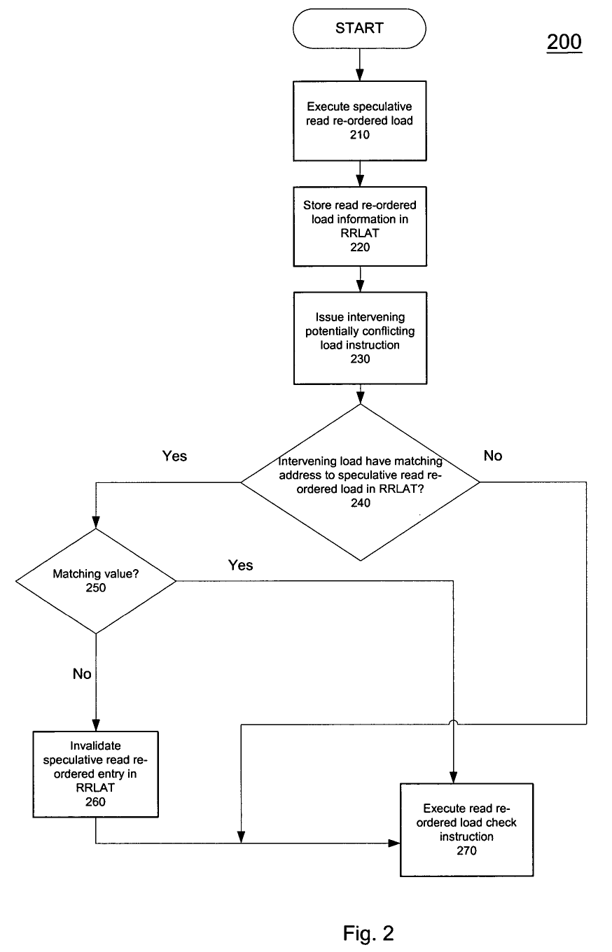

FIG. 2 is a flow diagram representing one embodiment of a method 200 for implementing a read re-ordered load operation, using RRLAT 160 or an equivalent tracking mechanism. At processing block 210, a speculative read re-ordered load is executed. At processing block 220, an entry is made in the RRLAT 160, identifying the target register, memory address, and value to be stored from the data being loaded, and setting the valid bit to indicate that the entry is valid. At processing block 230, intervening potentially conflicting load instructions are issued.

Monitor unit 164 compares the intervening load's physical address to the physical addresses of the speculative read re-ordered load entries in the RRLAT 160 at decision block 240. Other embodiments may employ an “imperfect match scheme”, for the sake of time optimization, that compares only some address bits to identify potential collisions. If a physical address match is detected, the monitor unit 164 further compares the value associated with the speculative read re-ordered load stored in the RRLAT 160 with the value associated with the intervening load, at decision block 250.

If the values associated with the intervening load and the speculative read re-ordered load are not the same, the entry in RRLAT 160 associated with the matching memory address is invalidated at processing block 260. In other embodiments, the RRLAT 160 entry may be invalidated after decision block 240 if a physical matching address is detected.

If the physical address associated with the intervening load has no matching address in the RRLAT, or if an RRLAT 160 entry has a matching address to the intervening load but also the same value, then no action is taken in the RRLAT 160 table on the read re-ordered load entry.

At processing block 270, the read re-ordered load check operation is typically executed at a point in the original program where the read re-ordered load operation was originally located, e.g. its location prior to being rescheduled above the potentially conflicting load. In one embodiment, the read re-ordered load check operation reads the RRLAT 160 entry associated with the memory address referenced by the speculative read re-ordered load. If the valid bit of the entry is set to valid, the results returned by the read re-ordered load are assumed to be valid (not stale) and control passes to the following instruction in the sequence.

If the valid bit of the entry is set to invalid, the results returned by the read re-ordered load are assumed to be “stale”, e.g. one or more relevant load operations may have referenced a different value in the same memory address of the speculative read re-ordered load after it was accessed by the speculative read-reordered load. In this case, a recovery procedure would be executed.

While the operations of the method 200 are shown sequentially, the present invention is not limited to the disclosed sequence. For example, executing processing block 210, the read re-ordered load, and initiating processing block 220, the RRLAT 160 entry, may occur in parallel or the RRLAT 160 entry may be initiated before the read re-ordered load is executed. Similarly, monitoring the intervening load instruction, decision blocks 240 and 250, and updating the RRLAT 160, processing block 260, may occur in parallel.

In general, the disclosed methods permit certain operations that are shown as sequential to be reordered or implemented in parallel, and the present invention is not limited to the specific ordering shown. Persons skilled in the art and having the benefit of this disclosure will recognize where particular sequences are to be observed.

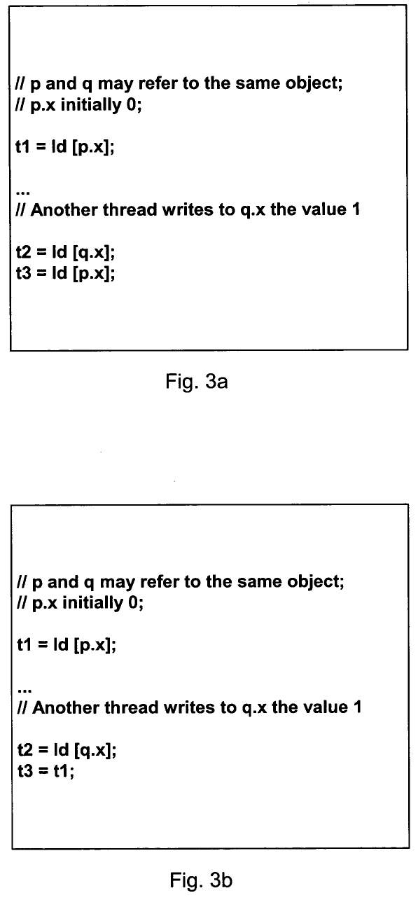

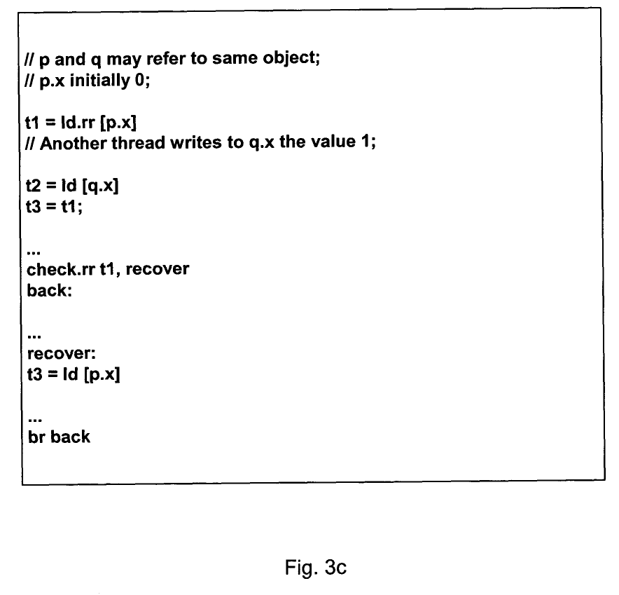

FIGS. 3a, 3b, and 3c demonstrate an example of read re-ordered load speculation in one embodiment of the present invention. FIG. 3a illustrates an original code instruction sequence. In this example, p and q may collide; the compiler cannot statically determine whether these references reference the same memory location. An optimizing compiler would usually eliminate the redundant load p.x as shown in FIG. 3b.

FIG. 3b illustrates the reordering an optimizing compiler would implement on FIG. 3a's original code instruction sequence. But, if p and q refer to the same memory location at runtime, such an optimization violates the read kills constraint described above. For example, if another thread were to write the value 1 to q.x in between the first and second load, the optimized code would see the new value in t2 and then the old value in t3. Note that the elimination of the second load of p.x is semantically equivalent to reordering it with the earlier load to q.x. The same problem occurs if the compiler's scheduler reorders these loads.

FIG. 3c illustrates the process of one embodiment for optimizing the code, while obeying the read kills constraint. The first load from p.x is implemented as an ld.rr instruction. The load from q.x is implemented as a normal load. The second load from p.x is eliminated as speculatively redundant. Finally, a read re-ordered load check instruction, check.rr, tests the validity of the speculation and branches to recovery code that performs the eliminated load and any dependent instruction if necessary. If another thread stores the value 1 into the location p.x, and p=q, the load from q.x will invalidate the entry for the read re-ordered load, thus causing the speculation check to fail.

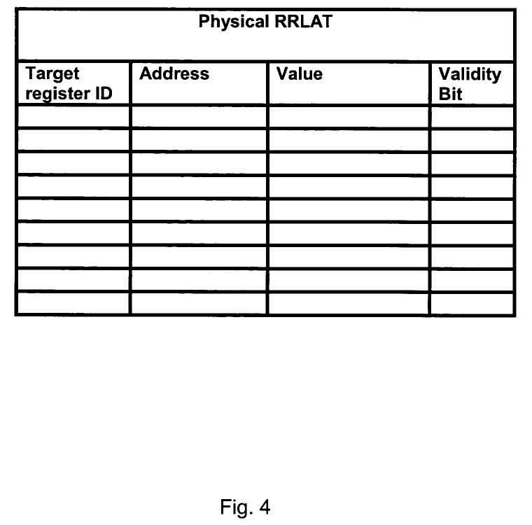

The above-described processes are implemented using RRLAT 160. FIG. 4 illustrates one embodiment of RRLAT 160. For each read re-ordered load, an entry is made in the RRLAT 160. In operation the RRLAT 160 includes data for each read re-ordered load, including target register identification data, target address data, value to be loaded data, and validity data. Thus in one embodiment of the invention, for each read re-ordered load four fields of data are entered into the RRLAT 160 array as shown in FIG. 4. The RRLAT 160 may be organized as a direct-mapped, multi-way set associative, or fully-associative data structure. These disclosed data structures are exemplary, and not an exhaustive list of possible data structures of the RRLAT 160.

The target register data is the unique register identification of the register targeted by the read re-ordered load. This identification or tag is used to look up data in the RRLAT 160 when the read re-ordered load check operation is subsequently performed. A unique identifier is needed to correlate a particular read re-ordered load with its corresponding read re-ordered load check.

In one embodiment, the physical index of the read re-ordered load's target register within the microprocessor's register file is used as the register identification data. In another embodiment, the physical index of the read re-ordered load's target register plus one or more bits is used. The latter embodiment may be advantageously employed in an implementation having a rotating register stack where, consequently, multiple copies of a particular register might exist at a given time. This embodiment may also be used in an implementation that includes multiple register sets where multiple registers could have the same physical indexes.

The target address data is a subset of the entire address of the read re-ordered load; however the entire address, rather than a subset, may be used if desired. This address data is used to compare with later potentially conflicting load operations, to determine whether or not a collision occurs.

The value data consists of the value loaded by the read re-ordered load upon its execution. This value data is compared with potentially conflicting load operations that have a matching address to the RRLAT 160 read re-ordered load entry, to determine whether the entry should be invalidated.

The validity data field, in one embodiment of the present invention, includes a single validity bit. In operation, the validity data field indicates whether or not the entry is valid, that is, whether or not the particular advanced load is/was safe to use. In one embodiment, the valid bit is set (i.e. set to a value that indicates that the entry is valid) when a new RRLAT 160 entry is made or allocated, and is cleared (i.e. set to a value that indicates that the entry is not valid or is/was not safe to use) if a later conflicting load operation is encountered.

According to another embodiment, a validity bit also may be cleared and thus an RRLAT 160 entry explicitly invalidated, by the execution of a specific instruction (like an instruction that flushes RRLAT 160 entries or a load check that invalidates an entry once it is checked) or by the occurrence of a particular event (like a snoop that hits an RRLAT 160 entry or a rotating register file wrap-around that would cause RRLAT 160 register identifiers to be reused).

In one embodiment, all validity bits in the RRLAT may be initialized to an invalid state. Thereafter, when an read re-ordered load operation is performed an entry is made into the RRLAT 160 entering target register, physical address and value information into the RRLAT 160 for the particular read re-ordered load. The validity bit may be set once the identification, address, and value data have been entered into the RRLAT 160.

In another embodiment, advanced loads that fail to complete properly, but are architecturally committed, may still allocate RRLAT 160 entries, but the validity bits of those entries may be cleared. In another embodiment of the invention, read re-ordered loads may be entered into the RRLAT 160 with their validity bits cleared for timing optimizations. In still another embodiment, read re-ordered loads which fail to complete properly are not entered into the RRLAT 160.

According to one embodiment, when a read re-ordered load check instruction is executed and the load check passes, the read re-ordered load is removed from the RRLAT 160. This embodiment may be found advantageous if the load will not be used again. According to another embodiment, the read re-ordered load is not removed, which may be advantageous if the load data is used again by a later instruction. According to yet another embodiment, when the RRLAT is full, an entry may be evicted.

According to yet another embodiment, the RRLAT 160 does not snoop other processor's memory access; it only monitors loads from its local processor. In another embodiment, software must invalidate the RRLAT 160 upon a thread context switch. In another embodiment, on multi-threaded micro-architectures, the RRLAT 160 must be partitioned among hardware thread contexts.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

1. A method comprising:
executing a speculative read-reordered load instruction;
storing memory conflict information representing the speculative read-reordered load;
matching an address of a potentially conflicting load against an address of the stored memory conflict information; and
invalidating stored memory conflict information with a matching address.

2. The method of claim 1, wherein the stored memory conflict information is invalidated if the stored memory conflict information has a different value than the potentially conflicting load.

3. The method of claim 2, further comprising executing a read re-ordered load check instruction to determine the validity of the speculative read re-ordered load.

4. The method of claim 1, wherein the memory conflict information is stored in a read re-ordered load address table (RRLAT).

5. The method of claim 5, further comprising updating the stored memory conflict information by setting a validity bit in the RRLAT to a valid state when new memory conflict information is stored.

6. The method of claim 6, further comprising setting the validity bit to an invalid state if a later conflicting load operation is executed.

7. A processor, comprising:
a RRLAT to store memory conflict information representing a speculative read re-ordered load; and
a monitor to compare a potentially conflicting load against the stored memory conflict information.

8. The processor of claim 8, wherein the stored memory conflict information is invalidated if the stored memory conflict has a matching address.

9. The processor of claim 8, wherein the stored memory conflict information is invalidated if the stored memory conflict has a matching address and a different value than the potentially conflicting load.

10. The processor of claim 10, wherein the RRLAT is referenced upon the execution of a read re-ordered load check instruction to determine the validity of the speculative read re-ordered load.

11. The processor of claim 8, wherein the RRLAT may be any one of a direct-mapped, multi-way set associative, and fully associative data structure.

12. The processor of claim 8, wherein the RRLAT is portioned among hardware thread contexts.

13. The processor of claim 8, wherein the RRLAT includes storage locations for an address, a target register ID, a value, and validity information associated with the speculative read re-ordered load.

14. A computer system, comprising:
a processor, including:
a RRLAT to store memory conflict information representing a speculative read re-ordered load;
a monitor to compare a potentially conflicting load against the stored memory conflict information, and to invalidate the stored memory conflict information if the stored memory conflict information has a matching address and a different value than the potentially conflicting load; and
a cache memory.

15. The computer system of claim 16, wherein the monitor unit executes a read re-ordered load check instruction to determine the validity of the speculative read re-ordered load.

16. A computer system, comprising:
a first processor; and
a second processor, including:
a RRLAT to store memory conflict information representing a speculative read re-ordered load received from the second processor; and
a monitor to compare a potentially conflicting load received from the first processor against the stored memory conflict information, and to invalidate the stored memory conflict information if the stored memory conflict information has a matching address and a different value than the potentially conflicting load.

17. The computer system of claim 19, wherein the monitor unit executes a read re-ordered load check instruction to determine the validity of the speculative read re-ordered load.

18. A computer system, comprising:
a processor, including:
a RRLAT to store memory conflict information representing a speculative read re-ordered load;
a monitor to compare a potentially conflicting load against the stored memory conflict information, and to invalidate the stored memory conflict information if the stored memory conflict information has a matching address and a different value than the potentially conflicting load; and
a cache memory; and
a memory device coupled to the processor.

19. The computer system of claim 21, wherein the monitor unit validates stored memory conflict information with a matching address if the stored memory conflict information has a matching value to the potentially conflicting load.

20. The computer system of claim 22, wherein the monitor unit executes a read re-ordered load check instruction to test the validity of the speculative read re-ordered load.

21. The computer system of claim 21, further comprising a bus to control communications between the processor and the memory device.

22. A machine-readable medium storing a sequence of instructions that, when executed by a machine, cause the machine to:
execute a speculative read-reordered load instruction;
store memory conflict information representing the speculative read-reordered load;
match the address of a potentially conflicting load against the address of the stored memory conflict information; and
invalidate stored memory conflict information with a matching address if the stored memory conflict information has a different value than the potentially conflicting load.

23. The machine-readable medium of claim 25, the sequence of instructions, when executed by the computer system, further causing the computer system to validate stored memory conflict information with a matching address if the stored memory conflict information has a matching value to the potentially conflicting load.

24. The machine-readable medium of claim 26, the sequence of instructions, when executed by the computer system, further causing the computer system to execute a read re-ordered load check instruction to determine the validity of the speculative read re-ordered load.
